(19) United States
(12) Patent Application Publication
(10) Pub. No.: US 2007/0178309 A1
(43) Pub. Date: Aug. 2, 2007

(54) Polyphosphate ceramic and method of making same

(76) Inventor: Sidney Omelon, Toronto (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/700,859

(22) Filed: Feb. 1, 2007

Related U.S. Application Data
(60) Provisional application No. 60/763,895, filed on Feb. 1, 2006.

(51) Int. Cl. B32B 5/16

(52) U.S. Cl. 428/403

(57) ABSTRACT

The present invention describes a porous polyphosphate ceramic, which comprises a network of interconnected particles or fibers, each of these particles has an amorphous polyphosphate core and an outer dried polyphosphate hydrogel layer. The composition of the hydrogel polyphosphate layer includes an amorphous polyphosphate, water and a multivalent cation. The network is interconnected through connections made in a region of the hydrogel polyphosphate layer between adjacent integrated polyphosphate particles that is later dried. The invention also describes the method of producing the porous polyphosphate ceramic by adding water to polyphosphate particles, partially dissolving the particles, to produce a hydrogel layer, allowing the hydrogel layer between adjacent particles to integrate and drying the integrated particles to produce the porous ceramic.

### CROSS-REFERENCE TO RELATED APPLICATIONS

The present application claims priority on U.S. Provisional Patent Application Ser. No. 60/763,895 filed Feb. 1, 2006, the entire content of which is incorporated herein by reference.

### TECHNICAL FIELD

The present invention concerns a polyphosphate ceramic and the method of making the polyphosphate ceramic.

### BACKGROUND OF THE INVENTION

Polyphosphates (PO₃⁻)ₙ are a unique species of the phosphate (PO₄³⁻) family. They generally consist of phosphate ions that are connected to each other by sharing one or more bridging oxygen atoms, forming chains, rings or networks of phosphate poly-ions. The interesting properties of polyphosphates in solution and in the solid state offer a wide range of applications for polyphosphates.

The range of potential uses for polyphosphate ceramics is surprisingly wide. Polyphosphate constructs are currently used in the laboratory as a temporary substrate for studying tissue engineering because calcium polyphosphate is biocompatible, degradable, and its dissolution products are non-toxic. Lead-iron polyphosphate glass is a candidate material for vitrification of nuclear waste. Ammonium polyphosphates are used as fertilizers, and as a component of fire retardants. In solution, polyphosphate ions are used to prevent the build-up of scale and inhibit the corrosion within pipes carrying water, and are also a common food stabilizer.

Polyphosphate (PP) ceramic or glass material is a candidate biomaterial for tissue engineering. Particularly, crystalline polyphosphates which include multivalent cations such as, calcium polyphosphate, (Ca(PO₃)₂)ₙ are used successfully to fabricate porous, resorbable substrates used for cartilage tissue engineering (Waldman et al., Characterization of Carilaginous Tissue Formed on Calcium Polyphosphate Substrates in Vitro, J. of Biomedical Materials Research, 2002, 62(3):323-330; Kandel et al. U.S. Pat. No. 6,077,989; Seguin et al., Tissue engineered nucleus pulposus tissue formed on a porous calcium polyphosphate substrate, Spine 2004, 29(12):1299-1306). The biphasic tissue-engineered cartilage+PP ceramic substrate has been successfully implanted into osteochondral defects in sheep.

Polyphosphate anions have long been used as a means of treatment for hard water, polyphosphates act to tie up or sequester ions such as calcium, iron and magnesium, and reduce scaling in pipe. Polyphosphates, therefore also have applications in the water treatment and the mineral separations industries for separation processes such as flotation.

Unlike other calcium phosphate minerals such as hydroxyapatite or tricalcium phosphate, calcium polyphosphate (CPP) ceramic or glass is composed of linear polyphosphate chains. The ceramic or glass particles can be sintered into interconnected, porous constructs. The process used for fabricating calcium polyphosphate (CPP) involves three steps. The first step is the retrieval of quenched amorphous calcium polyphosphate ceramic from a polyphosphate melt, with a calcium to phosphorous molar ratio ˜0.5, quenched in deionized water. This quenched CPP ceramic is milled. A size fraction of interest is segregated, typically to a +105-150 μm size fraction powder for constructing an interconnected biomaterial for bone and connective tissue engineering. The powder is placed in an inert mold (graphite, platinum or zirconium) and heat-sintered to produce a ceramic calcium polyphosphate solid shape, which can then be cut and shaped as desired. The process was limited by the noble metals required during the heat sintering process, requires stringent process and environment control and long periods of time. The polyphosphate chains in the amorphous glass flow and crystallize during the sintering process. This crystallization increases the ultimate tensile stress (UTS) of crystalline CPP, which is higher than the UTS of amorphous CPP. Crystallizing CPP also decreases its dissolution rate; the dissolute rate of amorphous CPP is too slow to be useful as a sequestering agent and too fast to be useful as a reasonable cartilage tissue engineering substrate (Porter et al., Solid Freeform Fabrication of Porous Calcium Polyphosphate: Processing Parameter and In Vitro Degradation Characteristics, J. of Biomedical Materials Research, 2001, 56(4):504-515).

To date, the only method of producing an interconnected porous CPP solid was by the application of heat through traditional sintering at high temperatures for extended periods of time in inert molds, and controlled atmospheric conditions within the furnace. Silicate glasses can be heated and deformed between their softening point (Tₛₚ), defined when the viscosity of the glass is 4×10⁷ P (poise), and working point, when the viscosity of the glass is 10⁴ P (Callister, Polymer Structures, Materials Science and Engineering: An Introduction, John Wiley and Sons, 2003: 470)-p. 424). Glass points can also be determined with differential scanning calorimetry. Ropp, (Inorganic Polymeric Glasses, New York: Elsevier, 1992: 116-185 at page 117) demonstrated a short working range of CPP glass that is made from CPP that was molten for longer than 10 hours. There is a shorter working range between the softening point, when the glass can be deformed, and the devitrification temperature (T_{d}), when the CPP glass crystallizes. CPP glass made from a melt that was held in the molten state for less than 10 hours (ibid. p. 129) devitrifies anomalously at temperatures below the CPP glass softening point 560-615° C. (ibid. page 130) as noted by Filiaggi, M. et al., (On the Sintering Characteristics of Calcium Polyphosphates. Key Engineering Materials Vols. 192-195, 171-174. 2001 at the Proceedings of the 13th Int. Symp. on Ceramics in Medicine, Bologna, Italy, 22-26 Nov. 2000. Gianni, S. and Moroni, A. 2000.) This anomalous crystallization at temperatures of or below the softening point complicate sintering by heat treatment.

Sodium and/or potassium polyphosphate glass dissolves rapidly in water, but fine powders of calcium and other multivalent polyphosphates transform into a hydrogel before dissociating completely (Kasuga et al., Hydrogelation of Calcium Metaphosphate Glass, Chemistry Letters 2001; (8):820-821; Dion et al., The effect of processing on the structural characteristics of vancomycin-loaded amorphous calcium phosphate matrices, Biomaterials 26, 4486-4494, 2005).

There is a strong ionic association between multivalent cations and linear polyphosphate ions in water, which can result in the formation of a viscous solution or a hydrogel (Galembeck, Aluminum Polyphosphate Gels Structural Evolution Probed by NMR Spectroscopy, J. of the Brazilian Chemical Society, 2003, 14(6):930-935; Van Wazer et al., Structure and Properties of the Condensed Phosphates, IV, Complex Ion Formation in Polyphosphate Solutions, J. of the American Chemical Society, 1950; 72(2):655-663; de Oliveira Lima et al., Thermoreversible Gel Formation from Aqueous Aluminum Polyphosphate Solution, J. of Colloid and Interface Science, 1994, 166(2):309-315; Umegaki et al., Viscosity Behaviour of Coacervates of Magnesium and Calcium Highpolyphosphates, Bulletin of the Chemical Society of Japan, 1975; 48(5):1452-1454; Montagne et al., Mechanism of polyphosphate gel formation in the Na₂O—Al₂O₃—P₂O₅ system, J. of Non-Crystalline Solids, 1993, 155(2):115-121; Abreu Filho et al., Genesis of Solid Foam, Iron(III) Metaphosphate Transformation in Sol-Gel Crystallization Processes, Langmuir, 1990; 6(5):1013-1016).

This formation of a hydrogel results in a complicated dissolution mechanism for calcium polyphosphate glass. Interestingly, sodium polyphosphate glasses dissolve rapidly in water, dissociating into Na+ and polyphosphate anions. Calcium polyphosphate glasses transform into a hydrogel before the ions dissociate completely into deionized water. Kasuga et al. (supra) and Dion et al. (supra) have both reported fabricating calcium polyphosphate hydrogels by mixing very fine (−45 μm) calcium polyphosphate glass particles with water. Calcium polyphosphate hydrogels can be stable for 2 days if they are prevented from drying (Kasuga et al. (supra)).

Galembeck (supra) and de Oliveira Lima et al. (supra), reported polyphosphate hydrogel formation for aluminum polyphosphates formed by mixing a solution of sodium polyphosphate with aluminum, nitrate, sulphate or chloride. It is multivalent cations that can bridge between linear polyphosphate chains, effectively forming a bridged network polymer that can form a hydrogel, as first reported by Van Wazer (supra) and Campanella (supra).

Amorphous, porous calcium polyphosphates can be sintered without crystallizing at low temperatures, and/or with short holding times (Illingworth, Sintering Characteristics of Calcium Polyphosphate, University of Toronto, 2005).

However, there is a need to produce a polyphosphate ceramic which has a dissolution rate that can be varied depending on its end use and which can be produced without the use of inert molds at high temperatures.

There is also a need to produce porous, degradable multivalent polyphosphate constructs through a novel fabrication process that offers more processing flexibility and lower cost than that presently known in porous calcium or other cation polyphosphate production processes.

### SUMMARY OF THE INVENTION

In one aspect of the present invention there is provided a porous polyphosphate ceramic comprising: a network of interconnected polyphosphate particles, each interconnected polyphosphate particle comprising a polyphosphate core having an outer layer of a dried polyphosphate gel, the gel forming an outer surface of each particle, the dried polyphosphate gel comprising an amorphous polyphosphate, a multivalent cation, and a solvent, wherein adjacent interconnected polyphosphate particles integrate in a region of their respective outer layers to form the network.

In another aspect of the present invention there is provided a method of producing a porous polyphosphate ceramic comprising: a)providing a plurality of particles of a polyphosphate, of a multivalent cation; b)adding solvent to the plurality of particles to partially dissolve the plurality of particles and to produce a hydrogel on outer surfaces of the particles; c)allowing the hydrogel on the outer surfaces between adjacent particles to integrate; and d)drying the thus integrated particles to produce the porous polyphosphate ceramic.

### BRIEF DESCRIPTION OF THE DRAWINGS

Further features and advantages of the present invention will become apparent from the following detailed description, taken in combination with the appended drawings, in which:

FIG. 1.—is a schematic representation of a polyphosphate identifying bridging (BO) and non-bridging oxygen atoms (NBO);

FIG. 2—is a schematic representation of two chains of polyphosphate with a multivalent (calcium) cation cross-linking the polyphosphate chains;

FIG. 3—is a schematic representation of an aqueous sintering process according to one embodiment of the present invention including the steps: (a) providing an amorphous polyphosphate particle; (b) producing a polyphosphate gel formation on the surface of amorphous polyphosphate particles in water, allowing neighboring gel layers to integrate; (c) drying of the contacting polyphosphate particles; and (d) sinter neck formation;

FIG. 4—is a Scanning Electron Microscope (SEM) image of fused, amorphous calcium polyphosphate particles;

FIG. 5—is a SEM image of an example of calcium polyphosphate glass particle;

FIG. 6 (Prior Art)—is a SEM image of calcium polyphosphate crystalline fibers produced according to U.S. Pat. No. 4,360,625;

FIG. 7—is a graphical representation of the percentage change in calcium polyphosphate (CPP) sample weight with wet-dry cycle: CPP glass only, CPP glass with 1 wt % CPP crystalline fibers, CPP glass with 10 wt %, CPP crystalline fibers;

FIG. 8—is a graphical representation of the change in percent weight with soaking time of calcium polyphosphate;

FIG. 9—is a graphical representation of the change in solvent calcium, ortho-phosphate and total phosphate ion concentration with soaking time;

FIG. 10—is a Backscattered Electron (BSE) image of (a) aqueous sintered CPP particles (24 hours in 0.02 M disodium-EDTA); and (b) samples from (a) after 1 hour at 600° C. in nitrogen;

FIG. 11—is a schematic representation of four-point bending test apparatus;

FIG. 12—is a Powder X-ray diffraction pattern acquired from (a) EDTA-affected CPP construct (600° C., 1 minute, nitrogen); (b) aqueous-sintered CPP glass (600° C., 1 minute, nitrogen); and (c) EDTA-affected CPP construct (600° C., 1 hour, nitrogen);

FIG. 13—is a graphical representation of the calcium concentration versus polyphosphate gel solvent type after 24 hours of contact with calcium polyphosphate glass particles;

FIG. 14—is a graphical representation of a thermogravimetric analysis of (a) CPP glass from the melt; and (b) CPP glass exposed to the aqueous sinter process;

FIG. 15—is a Backscattered Electron (BSE) image of various particles at various process steps according to one embodiment of the present invention (a) water-sintered CPP particles; (b) water-sintered CPP particles after firing for 1 hour in nitrogen at 600° C.; and (c) heat-sintered CPP glass particles after 1 hour at 585° C. and 1 hour at 950° C. in 30-40% humid ambient air (each image is repeated at 100×, 500× and 1,000× magnification);

FIG. 16—is a PAGE separation of pure CPP glass dissolution products in 1M EDTA (pH 9) for 1 hour (lane 4) run alongside sodium polyphosphate standards, Lane 1 contains pyrophosphate (P₂O₇⁴⁻) and a trimetaphosphate ring (PO₃)₃⁻. Lane 2 contains pyrophosphate and a small amount of (PO₃⁻)ₙ where n˜41. Lane 3 contains (PO₃⁻)ₙ where n˜28 and orthophosphate (PO₄³⁻);

FIG. 17—is a SEM image of a CPP glass particle (a) after one year storage in ambient air and (b) after a 30 second deionized water wash; and

FIG. 18—is a series of Powder X-ray diffraction patterns acquired from (a) CPP glass after the aqueous sintering process; (b) sintering of amorphous CPP glass (590° C., 1 hour, nitrogen gas); (c) sintering of amorphous CPP glass (after heating at 585° C., 1 hour, 30-40% humid ambient air); and (d) heat treated (30 minutes in N₂ at 600° C.), aqueous sintered CPP.

### DETAILED DESCRIPTION OF A PREFERRED EMBODIMENT

Calcium polyphosphate glass particles made according to the present invention, sinter without the use of a furnace at temperatures below the softening point of the polyphosphate glass.

It is now understood that amorphous interconnected porous polyphosphates can also be produced by a process very similar to traditional sintering, without using heat. This phenomenon is possible because multivalent cation, or mixes of monovalent and multivalent cation polyphosphates can exist in three solid forms: crystalline, amorphous and gel.

Although the formation of polyphosphate gels by dissolving small particles of multivalent cation polyphosphate glass or mixing sodium polyphosphate with soluble multivalent cation salts is known, a partial transformation of polyphosphate ceramic or glass particles to a gel, allowing the so formed gel surfaces to interact, then drying the gel surfaces, which then solidify into a phosphate glass with a higher water content than the initial PP glass, is new to the art of polyphosphates. The partial transformation process of the present invention, produces an interconnected, porous, amorphous polyphosphate ceramic.

The interconnection between adjacent polyphosphate particles resembles the sinter necks formed at high temperature although they have been formed at room temperature through the aqueous sintering process of the present invention. The process of the present invention is a polyphosphate gel-mediated sintering process and the interconnecting of the particles is believed to form through two mechanisms. The first is the intermingling of polyphosphate chains from neighbouring polyphosphate gel layers, and second through a multivalent cation cross-linking or chelation between polyphosphate chains within polyphosphate gel outer layers of two neighbouring particles.

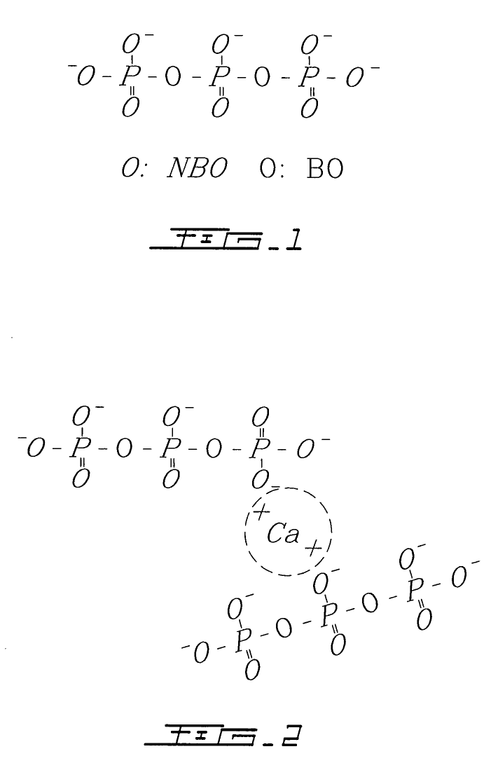

The second mechanism discussed above, is believed to be that which principally strengthens the polyphosphate gel and sinter neck through the formation of linkages with hydrated mobile multivalent cations. Referring to FIG. 1, we see that within a polyphosphate gel, these cations are able to bond with any two “non-bridging” oxygen atoms. “Non-bridging” oxygens (NBO) are identified and are italicized in FIG. 1 as the oxygen atoms that are not included in the —P—O—P— backbone of the linear polyphosphate chain. NBOs are located on the ends and along the sides of the linear polyphosphate chains. FIG. 1 further identifies the Bridging oxygens (BO) as having two bonds associated with two phosphorous atoms (and non-italicized) and are situated along the —P—O—P— backbone.

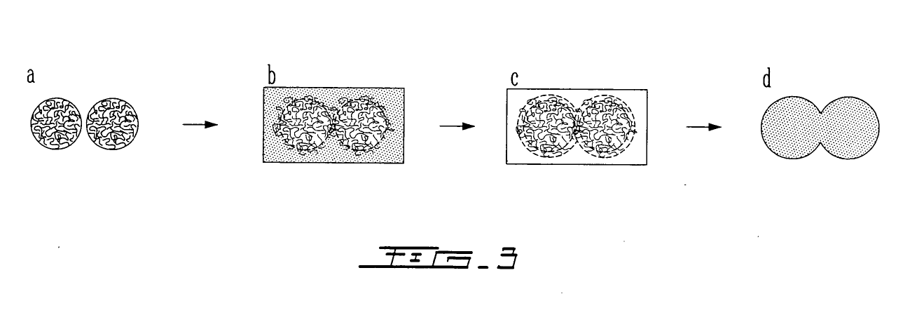

When dried, it is believed that an important contributor to the strength of the water-containing polyphosphate ceramic that aqueously sinters neighbouring polyphosphate particles and/or fibers is the multivalent polyphosphate cations, such as, the divalent calcium illustrated in FIG. 2. These multivalent cations act as cross-linking agents to connect the polyphosphate chains together in a network. Although only one such multivalent cation molecule is represented in FIG. 2, it is easy to visualize the possibility of a plurality of such cations bonding the polyphosphate chains along their length. It is understood that a plurality of multivalent cations produce a strong link between polyphosphate chains that are grounded within the polyphosphate ceramic particle core, polyphosphate chains that extend into the layer of dried polyphosphate gel on the surface of the polyphosphate particle, and polyphosphate chains originating from two polyphosphate gel surfaces in contact with each other.

Suitable multivalent cations include: calcium, magnesium, iron, strontium, aluminium, titanium and barium. Calcium and magnesium cations used separately or in combination representing preferred embodiments.

It must be understood that although monovalent cations do not typically form a polyphosphate gel, instead, monovalent polyphosphate glasses more readily dissolve than multivalent polyphosphate glasses. The use of monovalent cations in combination with multivalent cations vary the properties of the porous ceramic produced. The addition of monovalent cations: allows for faster dissolutions rates, and varies the crystallization properties of the ceramic. These properties are useful for specific applications, including but not limited to water or mineral treatment and biomaterial constructs. The monovalent cations that are appropriate for mixtures with multivalent cations include, but are not limited to: H⁺, silver, lithium, sodium, potassium and ammonium. In a preferred mixture hydrogen, sodium or potassium alone or in combination are mixed with calcium and/or magnesium cations.

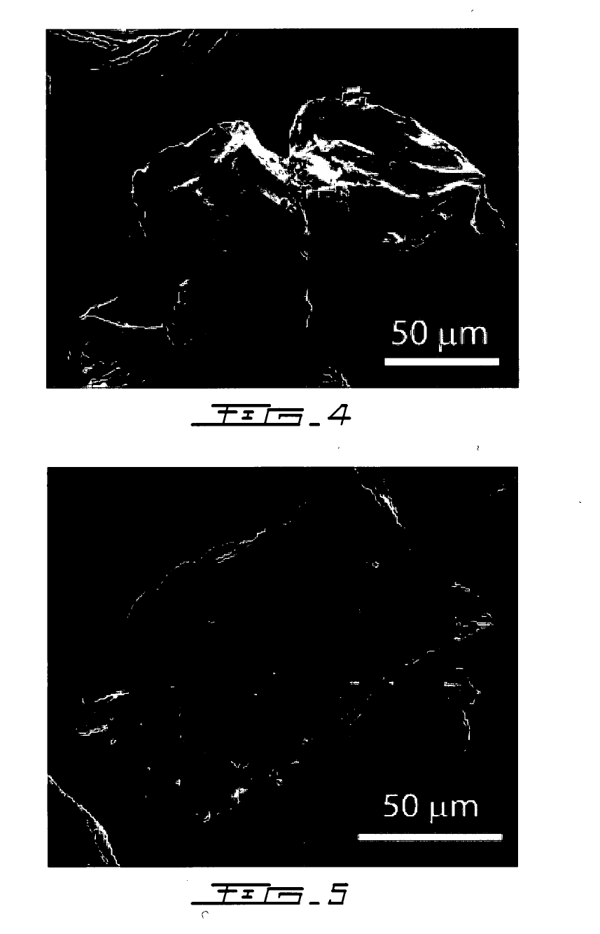

Polyphosphate chains within the hydrogel may also migrate and intermingle with polyphosphate chains located within the hydrogel layers of neighbouring particles or fibers. The polyphosphate chain intermingling and the overall aqueous sintering process is presented in FIG. 3.

FIG. 3 presents a schematic representation of the process of the present invention where step (a) illustrates the providing of the starting material, of particles or a cross-section of a fiber of multivalent cation polyphosphate (MVCPP) glass.

The disorderly curved lines in FIG. 3 represent the disordered polyphosphate chains. Step (b) shows the formation of the multivalent cation polyphosphate gel on the surfaces of neighbouring polyphosphate glass particles wherein a preferred solvent is deionized water. Although it is understood that the use of deionized water in step (b) as a solvent is a preferred embodiment meant to increase the compositional uniformity of the multivalent cation polyphosphate produced and thus minimize the types of cations found therein, water including various dissolved minerals and comprising numerous cations may also be used. Aqueous solutions or other suitable solvent, containing known quantities of multivalent and monovalent cations alone or in combination may be formulated to produce the porous polyphosphate ceramic with specific properties of dissolution and solidity. Solvent mixtures which include solvents such as ethanol alone or in combination, are envisaged for disinfecting the ceramic construct. The amorphous nature of the hydrogel is not substantially different from that of the starting polyphosphate although the amorphous gel structure may include polyphosphate chains of decreased chain length as well as more —P—OH groups.

The operation of step (b) in FIG. 3 may be done in a variety of ways but in a preferred embodiment the contact time between the solvent and the multivalent cation polyphosphate solids is such that the increase in dry weight of the final dry solid varies from less than 1 to 20% by weight of the total polyphosphate starting material.

The solvent-PP glass contact time allowed before drying begins, also varies. Contact times from seconds to hours may be envisaged and depend primarily on the solvent composition, solvent temperature, and on the cation(s), both multivalent and monovalent found in the polyphosphate.

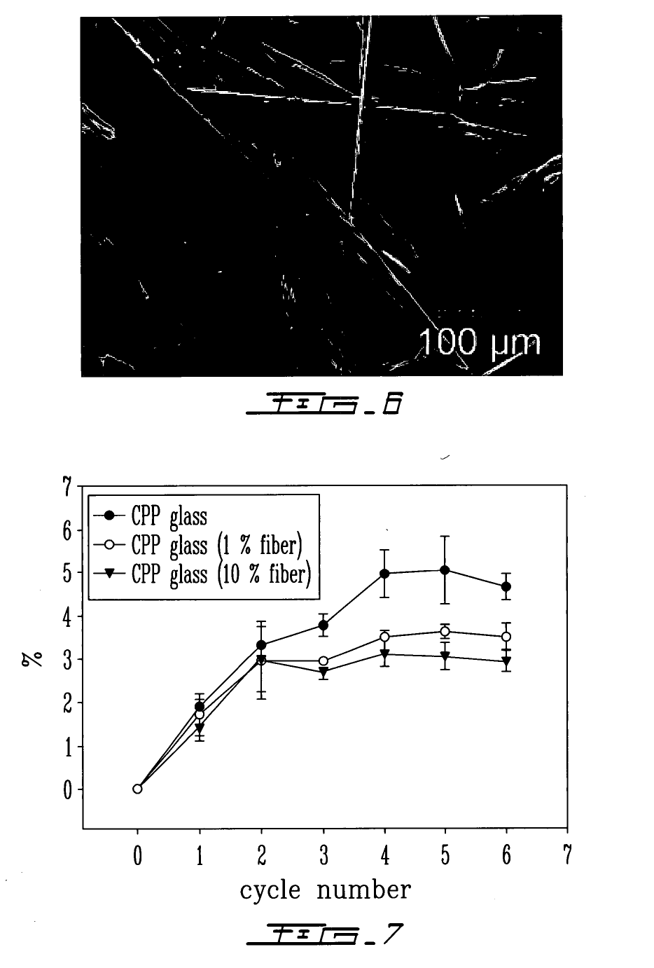

The contacted particles and/or fibers are dried as represented in step (c) of FIG. 3 where they are removed from direct contact with water. The interconnection between adjacent particle or an “aqueous sinter neck” connection is produced. The integration of a region of the polyphosphate gel layer between adjacent or neighbouring polyphosphate particles is such that more than one linking or “aqueous sinter neck” can be made. Step (d) of FIG. 3 represents the forming of the “sinter neck” in the dried compound. A Scanning Electron Microscope (SEM) image of a calcium polyphosphate produced by the process of the present invention is given in FIG. 4.

The present invention provides a proposed mechanism and method of sinter neck formation during the aqueous sintering process described, and is a means to produce a stronger, porous, sintered multivalent cation polyphosphate ceramic construct formed by reinforcing aqueous-sintered multivalent cation polyphosphate, with a reinforcing fiber such as, but not limited to crystalline multivalent cation polyphosphate fibers.

A construct is understood as a substrate that can be used in tissue engineering research that can offer flexible shapes, sizes, porosities, strengths and dissolution rates. These biomaterials substrates of calcium polyphosphate can inhibit calcification when implanted, which is contrary to other biomaterials that often tend to calcify.

Definitions within the Specification

Polyphosphate Gel and Hydrogel—The phenomenon of gel formation or gelation is complex. The definition proposed by Brinker et al. (Brinker, C. J., and Scherer, G. W. Sol-Gel Science: The Physics and Chemistry of Sol-Gel Processing. Academic Press Inc., Harcourt Brace Jovanovich, Publishers, Toronto, 1990 p. 304.) gives an indication of the complexity of gels: “The simplest picture of gelation is that clusters grow by condensation of polymers or aggregation of particles until the clusters collide; then links form between the clusters to produce a single giant cluster that is called a gel . . . . At the moment that the gel forms, many clusters will be present in the sol phase, entangled in but not attached to the spanning cluster; with time, they progressively become connected to the network and the stiffness of the gel will increase”.

With the polyphosphate gels of the present invention, the polymers are polyphosphate chains, and the predominant links thought to form are between multivalent cations and non-bridging oxygen atoms. Throughout the specification the terms: polyphosphate gel and hydrogel, will be used interchangeably, and are thus considered synonyms.

Ceramic and glass—Furthermore, throughout the specification the words—ceramic and glass—are used as synonyms with regard to the polyphosphates of the present invention. Although, a ceramic is usually defined by what it is not: it is nonmetallic and inorganic; thus ceramics may be crystalline, non-crystalline (amorphous) or a combination thereof.

Particle and fiber—a particle, is understood as a solid material with a finite mass having a particular shape. This shape may be any one of many shapes including but not limited to: spherical or spheroid, such as the case for milled glass particles, however the particle may also be elongated, such that the particle may be considered to be a fiber. Fiber particles of polyphosphate poly-ions can be amorphous or crystalline, and may be incorporated within the network of interconnected polyphosphate particles by integration through the polyphosphate gel layer. It must be understood that the term particles includes fibers throughout the specification.

Reinforcing Phase—The reinforcing phase may be used in conjunction with the polyphosphate ceramic, thus producing a composite material. Therefore the reinforcing phase, may be one or a more of materials, (including but not limited to particles, fibers, sheets or filaments) that are embedded in the polyphosphate gel layer. The polyphosphate gel which includes within and in cooperation with neighbouring polyphosphate particles in the ceramic network. A demonstrated reinforcing phase is crystalline calcium polyphosphate fibers, however due in large part to the low process temperature requirements of the present invention other reinforcing phases such as other polymers and other ceramics may also be mixed within the polyphosphate gel. The reinforcing phase therefore typically reinforces the ceramic of the present invention, through the polyphosphate gel, and outside the core of the (MVCPP) glass particles.

### EXPERIMENTAL DATA

Calcium polyphosphate (CPP) glass particles were fabricated with the method published by Pilliar et al. (supra). In short, calcium polyphosphate glass was formed by calcining monocalcium phosphate monohydrate (Ca(HPO₄)2.H₂O, Aldrich) at 500° C. for one hour, then melting the calcine within a platinum crucible at 1000° C.-1100° C. for one hour in air. The melt was frozen in deionized water and ground in an agate mill. The +105-150 μm-size fraction was collected by sieving polyphosphate powders of irregular shapes and is represented in FIG. 5.

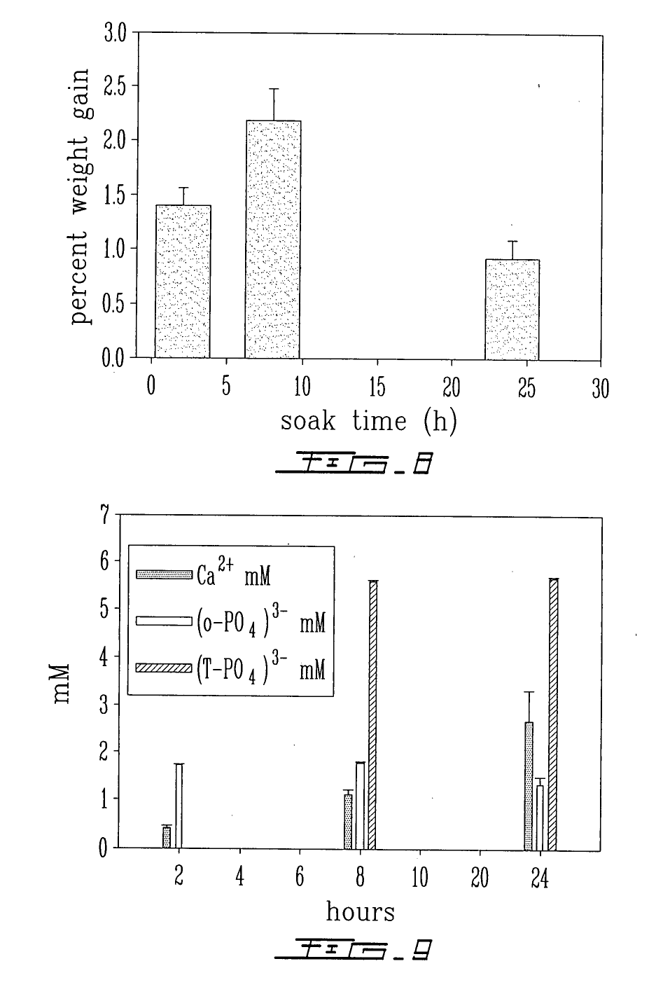

Crystalline calcium polyphosphate (CPP) fibers were made according to the process described by Griffith U.S. Pat. No. 4,360,625. In short, a calcined mix of calcium carbonate and phosphoric acid was melted in a platinum crucible for 1 hour at 1000° C., cooled to 800° C., then seeded with a few solids of sintered CPP particles. Acicular crystalline CPP fibers grew from the melt within spherulitic-like shapes which were likely centered on the locations of the crystalline CPP seeds. After approximately two hours at 800° C., the CPP was cooled to room temperature. The acicular or needlelike CPP fibers (FIG. 6) were removed from the surface and separated from the frozen CPP glass by dissolving the CPP glass in water or slightly acidic solutions.

Aqueous Sintering Process—Weight Gain Versus Wet/Dry Cycle Number.

Two aqueous sintering methods are disclosed. In the first process, Calcium polyphosphate glass particles were placed in alumina molds, lined with Parafilm® and weighed. The mold may be fabricated of any material that is inert to the solvent. The Parafilm® mold liner is not required, but facilitates removal of the sintered construct from the mold. The mold liner is not limited to Parafilm®. The molds containing the CPP glass particles were slowly filled with deionized water, then dried at ambient temperatures. When dry, the molds and contents of the molds were weighed, then filled with deionized water a second time. This process was repeated until the change in specimen dry weight was not significant.

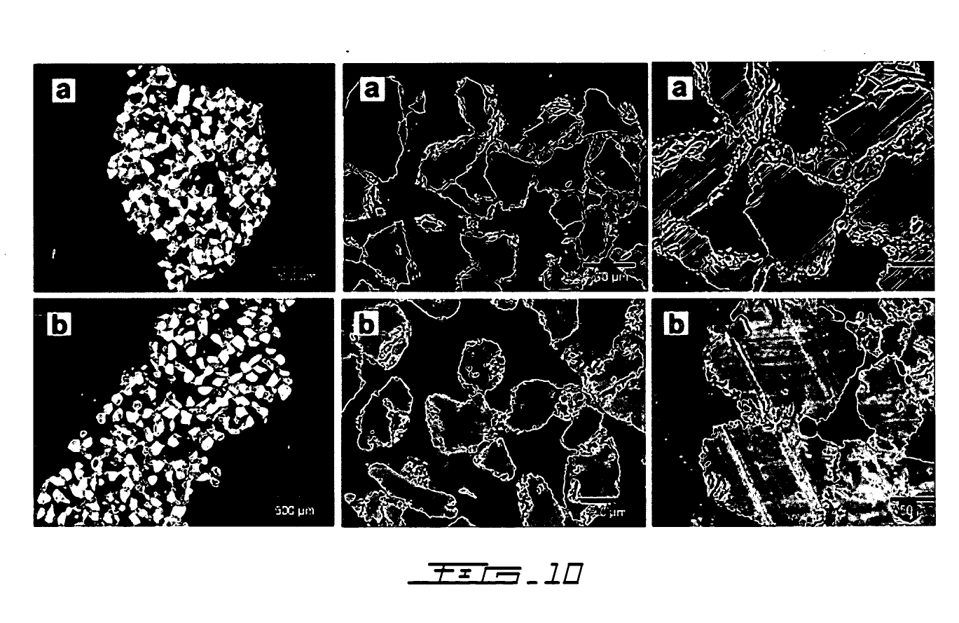

The change in porous sample mass measured with each cycle of exposure to water-drying is presented as a percent change in FIG. 7. The CPP glass weight gain increases linearly with the number of wet-dry cycles, until the fourth cycle when the percent change in mass tapers to a 4.6±0.4% gain (n=4, average initial weight=1.4±0.1 g).

The percent weight gain was reduced when the fraction of the crystalline, reinforcing CPP fibers was increased. Crystalline CPP fibers are not able to form a hydrogel; the calcium and polyphosphate ions are too close-packed for water to form a hydrogel between adjacent or neighbouring polyphosphate anions. The reduced weight gain of fiber-reinforced CPP constructs is due to both the reduced CPP glass content and available CPP glass surface area. For the first few wet/dry cycles, polyphosphate gel forms on the surfaces of the CPP particles, and sinter necks form between the fibers and the CPP glass particles. Where a connection between the crystalline CPP fibers and the CPP glass particles is made, this surface of the CPP glass particle is no longer exposed to solvent water. This reduces the amount of water that can be incorporated in future wet/dry cycles.

Preparation of Mixed Multivalent and Monovalent Polyphosphates.

Calcium polyphosphate glass containing a 1% substitution of calcium ions by two sodium or potassium ions (for an electroneutral product) was formed by adding the appropriate amount of sodium (as NaH₂PO₄) or potassium phosphate (as K₂HPO₄) to the monocalcium phosphate monohydrate before it was calcined. The glass formed from the melt therefore contained a small fraction of monovalent cations. The aqueous sintering process, specifically, exposing approximately 1 g of glass (particle size greater than 75 microns and less than 150 microns) contained within a mold to 50 mL of deionized water for 3 hours, removing and drying the mold and the polyphosphate glass contents, resulted in interconnected porous constructs made with phosphate glass with multi and monovalent cations.

Preparation of Magnesium Polyphosphate Gel.

The ability for other multivalent cations such as magnesium to form a polyphosphate gel was tested by adopting the method used by Galembeck (supra). With this method, equal volumes of 2 M (moles of PO₃⁻) solution of sodium polyphosphate (NaPO₃)ₙ, with an average chain length (n) of 41 and 1 M solution of magnesium chloride (hexahydrate) were mixed. This mixture, formed a translucent, gel substance within an aqueous solution. The mixed solution was acidic; addition of an adequate amount of sodium hydroxide solution to neutralize the magnesium polyphosphate-sodium chloride solution increased the amount of translucent gel. Because divalent magnesium ions are able to cross-link polyphosphate chains in solution, is proposed that dissolving magnesium polyphosphate glass would form an intermediate gel phase, as demonstrated with calcium polyphosphate glass and calcium-sodium and calcium-potassium polyphosphate glasses.

Aqueous Sintering Process—Effect of Water Exposure Time and Drying Time.

In a second process, a beaker was filled with 50 mL of either deionized water, 0.01 or 0.02 M EDTA, or 0.1 M HCl. An alumina mold 25×15×5 mm (Vesuvius), lined with Parafilm® and filled with approximately 1 g of CPP glass particles was slowly lowered into the beaker. The particles within the mold were slowly stirred within the mold in order to remove entrained air bubbles. The beakers were then sealed to prevent evaporative loss of the solution. The mold and its contents were carefully removed from the solutions after 2, 8 or 24 hours and then dried at 60° C. before weighing.

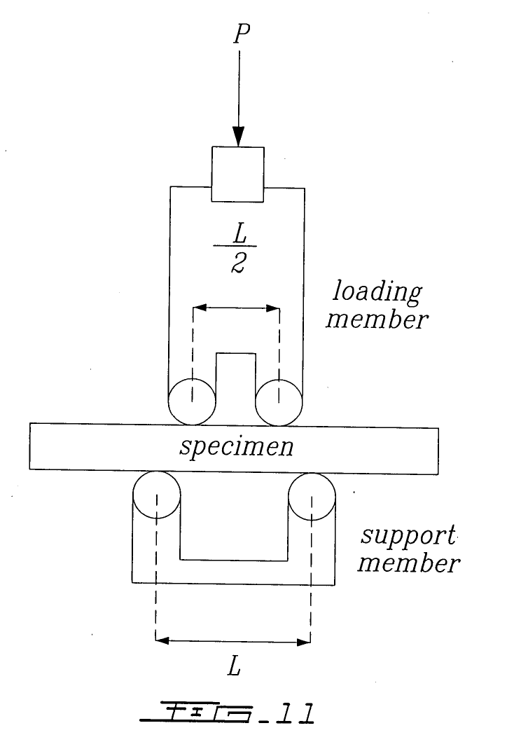

To determine the effect of soaking time on the aqueous sintering process, samples of CPP glass were soaked for 2, 8 or 24 hours in an “infinite sink” of deionized water only. The crucible containing the wet CPP glass was removed from the infinite sink of water, and dried at 60° C. for a minimum of 3 hours (n=6 or 9). The percent weight gain of sample groups increased up to 8 hours of soaking, and decreased slightly by 24 hours of soaking in deionized water (FIG. 8).

The concentration of calcium, ortho-phosphate and total phosphate for these sample groups exposed to water only is presented in FIG. 9. The concentration of calcium increases with soaking time. The total phosphate concentration is determined by hydrolytically degrading the polyphosphate chains in solution by boiling them at low pH in a closed vessel. The polyphosphate concentration of this solution is the “total phosphate concentration”. The orthophosphate concentration is the concentration of orthophosphate ions in the sample before acid hydrolytic degradation. From these results, a conclusion can be made that there are polyphosphate chains in solution, as the total phosphate concentration is higher than the ortho-phosphate concentration.

The increasing calcium concentration with polyphosphate gel formation time provides an explanation for the smaller increase in percent weight for the 24 hour time point. While the overall percent weight increases due to water entrapped by the dried polyphosphate gel, the decreased weight gain at 24 hours is attributed to the dissolution of CPP material into solution, reducing the weight of CPP in the specimen.

Hydrogel Disruption—Deliberate Interference with the Aqueous Sintering Process.

To clearly establish the mechanism of CPP glass aqueous sintering, two different sintering solvents were used that were expected to interfere with either the calcium chelation or the polyphosphate chain entanglement, causing the aqueous sintering process to fail.

The effect of calcium bonding between polyphosphate molecules was removed from the CPP hydrogel by adding disodium-EDTA [ethylene diamine tetra acetic acid] (0.01 or 0.02 M) to the aqueous sintering solution. The EDTA chelates with the calcium ions, while sodium or hydrogen ions are exchanged and associate with the polyphosphate anions.

The effect of polyphosphate chain entanglement would be eliminated if either the polyphosphate chains within the hydrogel were cut, reducing the average polyphosphate chain length in the hydrogel. This would reduce the probability that polyphosphate chains from neighboring hydrogel surfaces could become physically entangled, connecting the neighboring solids when dried. Cutting polyphosphate chains in the hydrogel layer was accomplished by using an acidic (0.1 M HCl) aqueous sintering solution, as acidic solutions increases the rate of polyphosphate chain hydrolytic degradation (Van Wazer, Phosphorus and Its Compounds, 1st ed., New York, Interscience Publishers Inc., 1958).

Effects of Chelating Calcium Ions with EDTA.

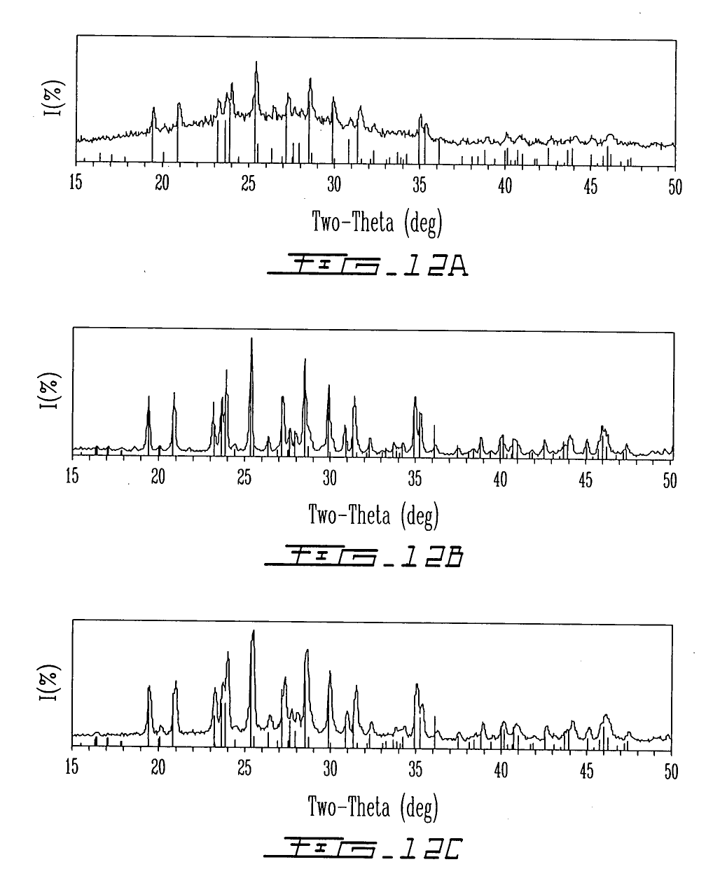

The effect of adding disodium EDTA to the aqueous sintering solution on the aqueous sintering product was not immediately evident. The dried CPP particles were interconnected in a similar manner to the aqueous sintered CPP solids made with deionized water, showing an outer layer and sinter necks that are less electron-dense than the CPP particle interior (FIG. 10(a)). When heat treated for one hour at 600° C. in nitrogen gas, the sinter necks appear less continuous than the fired sinter necks after aqueous sintering in deionized water (FIG. 10(b)).

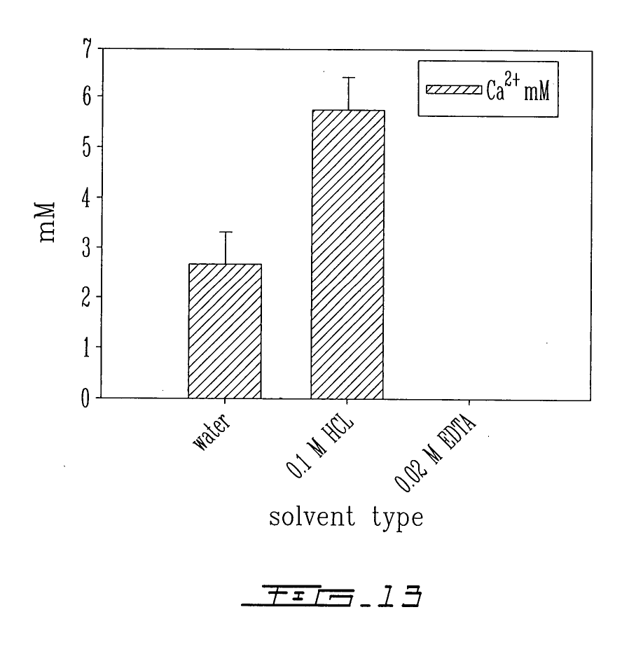

The effect of exchanging calcium ions for sodium and hydrogen ions within in the CPP hydrogel was made apparent after the porous solids were sintered (N₂, 1 hour) and tested in four point bending (FIG. 11). The solids were too weak to record a load with the load cell that was used to test aqueous-sintered CPP porous solids that were sintered in the same conditions (N₂, 1 hour). It was concluded that the lack of calcium cross-linking association between neighbouring polyphosphate chains was responsible for this lack of strength.

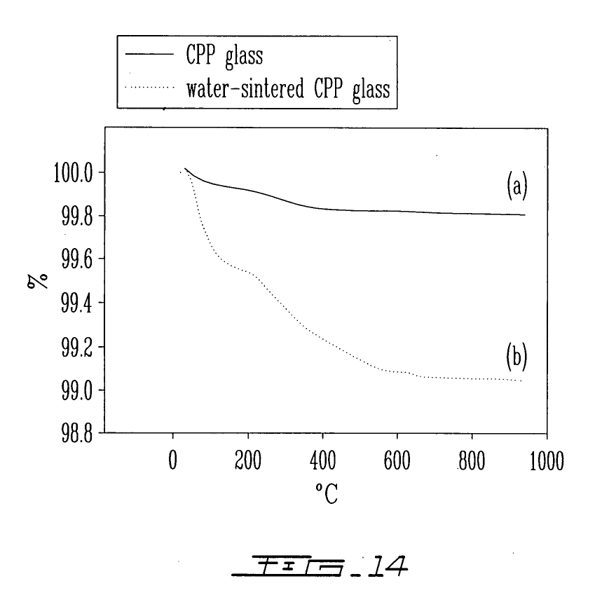

Another effect of EDTA exchange of calcium with monovalent ions in the CPP hydrogel on the sintered product was measured with powder-X-ray diffraction (PXRD). PXRD of the heat treated, aqueous-sintered CPP constructs formed in the disodium-EDTA solutions were not exactly the same as those for heat treated aqueous-sintered CPP constructs formed in deionized water only. FIG. 12(a) is the powder-X-ray diffraction pattern of the EDTA-affected CPP construct after 1 minute at 600° C. in nitrogen. A significant amorphous content remains, exemplified by the high “background” signal at low °2θ. This “background” signal is the PXRD result for glass. Instead of sharp peaks at particular °2θ values, one wide peak at lower °2θ values is measured, obscuring the crystalline CPP phase. After the same heat treatment, the aqueous sintered CPP with deionized water only is more crystalline (FIG. 12(b)). If the EDTA-affected CPP construct was sintered for 1 hour at 600° C., the amorphous content is reduced, but not completely eliminated (FIG. 12(c)).

It is believed that the reduced availability of calcium ions delays the formation of crystalline calcium polyphosphate. The heat treatment burns off any residual EDTA (an organic complex) within the dried polyphosphate gel material, releasing previously chelated calcium ions to associate with the polyphosphate anions.

Hydrogel Disruption: by Accelerating Polyphosphate Ions Hydrolysis with Acid.

CPP particles exposed to the 0.1 M HCl acidic solution were reduced to a singular mass of CPP hydrogel after the aforementioned time points. It is proposed that clipping the polyphosphate chains as they formed the CPP hydrogel with the acidic solvent facilitated the release of the smaller polyphosphate chains into solution, increasing the exposure of the eroding CPP glass surfaces to more acidic solution. Eventually, the entire CPP glass particle was transformed into a hydrogel, leaving behind no detectible solid glass particles.

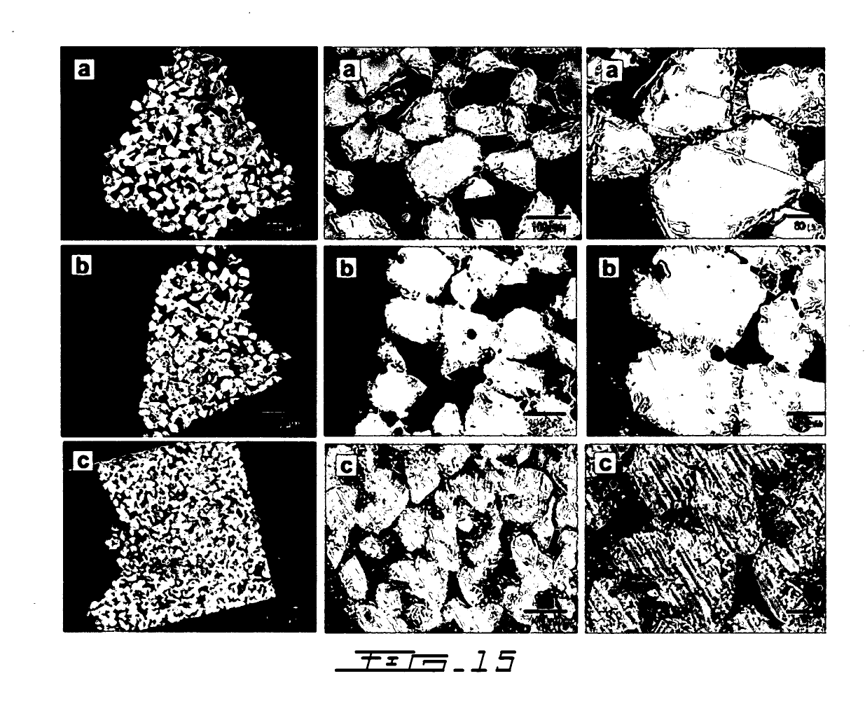

This accelerated chain hydrolysis and dissolution effect is supported by the elevated calcium concentration level in the acid solvent after 24 hours in contact with the CPP glass particles. FIG. 13 compares the calcium concentration measured in three hydrogel solvents (deionized water, 0.1 M HCl, 0.02 M disodium-EDTA) after 24 hours of contact time with the CPP solids (n=3).

There was no detectable calcium concentration in the hydrogel-forming solutions with disodium EDTA. The concentration of EDTA was high enough to chelate all of the free calcium in solution; as EDTA is a stronger chelator than the colourimetric complex used to detect calcium concentration (o-cresolphthalein), no colour signal was detected that would represent a calcium concentration.

Thermogravimetric Analysis (TGA).

The percent weight loss of CPP specimens per unit increase in temperature was measured with a Thermogravimetric Analyzer Q500 (TA Instruments). The balance chamber was purged with nitrogen gas before and during the experiment. 50-100 mg of CPP sample was placed in the titanium balance tray. The experiment ran from 25° C. to 900° C. with a ramp rate of 50° C./min from room temperature to 100° C., which was held for 10 minutes, followed by a ramp rate of 20° C./min up to 900° C.

In FIG. 11, the results of thermogravimetric analysis of the initial CPP glass (a) and a porous CPP glass construct that was made after 24 hours in the “infinite sink” of deionized water (b) are overlaid.

The breakdown of percent mass lost over three temperature ranges is given in Table 1. Three modes of weight loss are attributed to three temperature regions, assuming all weight losses are water (negative values of % weight change indicate a loss of weight). The mass loss up to 200° C. is attributed to physisorbed/surface water, the water lost between 200° and 400° C. is considered to be glass water lost through diffusion, and the final loss at 625° C. is either sudden crystal water loss and/or condensation water loss.

Two types of water can be emitted from the CPP sample: water found in the glass at the beginning of the experiment, and water formed during the heating process. Heating can cause the polyphosphate chains to condense. In condensation, one water molecule is released for every P—O—P bond formed. The water content of sintered CPP is significantly higher than the water content of the original glass. It is not possible to determine the source of the water lost during this TGA measurement.

TABLE 1
Percent change in CPP mass with temperature (25-900° C.)

| | Total % | | | % | Proposed |
|---|---|---|---|---|---|
| | weight | Temp. | | weight | lost |
| Sample | change | range | | change | material |
| CPP glass | −0.20% | 25-200° | C. | −0.08% | Surface water |
| | | 200-400° | C. | −0.1% | Crystalline |
| | | | | | water |
| | | 625° | C. | −0.02% | Condensation & |
| | | | | | crystalline |
| | | | | | water |
| Aqueous | −0.95% | 25-200° | C. | −0.4% | Surface water |
| sintered, | | 200-500° | C. | −0.5% | Crystalline |
| amorphous | | | | | water |
| CPP | | 625° | C. | −0.02% | Condensation & |
| construct | | | | | crystalline |
| | | | | | water |

It is believed that two phenomena may be responsible for the larger amount of surface/physically absorbed water observed for the water-sintered CPP glass. Because the dried CPP hydrogel is CPP glass with a larger water content, it is postulated that the dipole moment of water may be affecting the charges of the calcium polyphosphate species. This potentially renders the surface of the solid more susceptible to water molecule adsorption. Secondly, some polyphosphate chain cleavage may have occurred in the hydrogel, presenting more —P—OH end-chain species. A higher population of these end groups at the CPP glass surface may also attract and retain more water molecules.

The gradual loss of mass with increasing temperature between 200° C. and 600° C. is attributed to two sources: water molecules contained in the dried hydrogel, polyphosphate glass matrix, and the water vapour formed by polyphosphate chain condensation within the PP solid at these elevated temperatures via the Reaction 1.

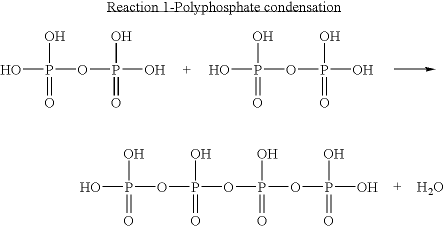

The loss is assumed to be gradual because the water must diffuse or otherwise exit out of the solid to the particle surface. Below 625° C., the mass lost from CPP glass (0.2%) is less than that lost from the CPP glass construct formed after the aqueous sintering process (0.9%). The increased mass loss is assumed to be the vaporization of the extra water that was taken up by dried CPP hydrogel material (CPP glass). However, if the aqueous sintering process caused polyphosphate chain hydrolytic degradation, this mass loss could also represent the loss of water that is formed by the condensation of these extra end-chain PO₃ groups during the TGA heating cycle.

The small loss of mass at approximately 650° C. observed for both samples is not clearly understood. It is believed that because 625° C. is close to the CPP glass softening point (615° C.) when the glass viscosity drops (Ropp (supra)—p. 130), the solid structure may suddenly yield to escaping water vapour. However, as gradual crystallization begins at low temperatures for CPP glass that was melted for less than 10 hours. As the sample crystallizes, the water molecules can no longer diffuse easily through the increasingly ordered structure around them. If the amorphous content at 625° C. is at its softening point, it will yield to escaping water vapour, but it will also be able to reorder and crystallize. A sudden release of water vapour followed by full crystallization is a possible explanation for the small drop in weight at 625° C.

Back-Scattering Electron Imaging with Scanning Electron Microscopy.

Calcium polyphosphate specimens were embedded in epoxy resin and sectioned with a wafering blade on an Isomet saw. Specimen sections were mounted and gold-coated for back-scattering electron analysis (FEI XL30).

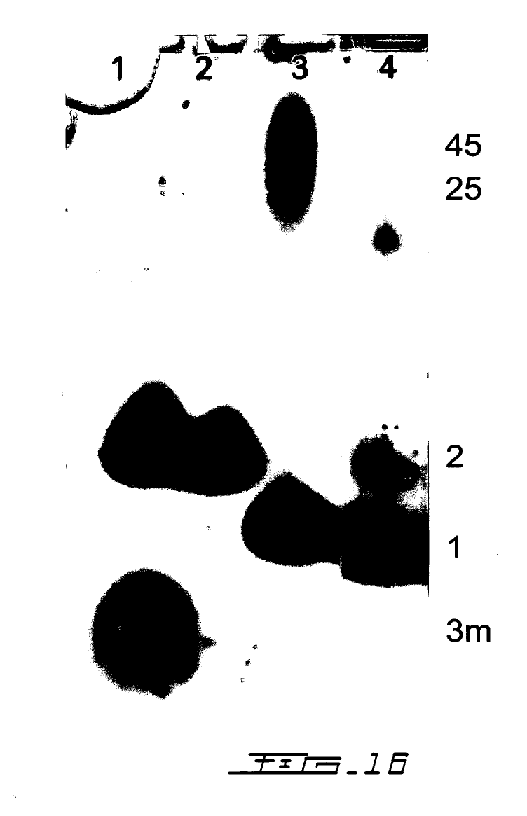

Back-scattered electron images of cut cross-sections of the porous sintered CPP identify areas of high and low electron density. Areas with high electron density are brighter than areas of low electron density. FIG. 15(a) shows cross sections of CPP glass after 48 hours of soaking in deionized water at room temperature, followed by ambient drying. The images are of the same specimen, magnified by 100×, 500× and 1,000×. In this cross-section, the interior of the glass particles are brighter than the exterior and the sinter neck regions. It is proposed that the exterior layer and sinter necks are the high-water content CPP glass that was formed after the CPP hydrogel layer dried.

When heated to 600° C. for one hour in nitrogen, the low-density shell around the CPP particles is brighter (FIG. 15(b)). For contrast, BSE images of CPP glass particles sintered at 585° C. for one hour, then 950° C. for a second hour in 30-40% humid ambient air are presented in FIG. 15(c). The uniform brightness of particles and sinter necks is evidence of uniform electron density throughout the sectioned construct.

Heating the aqueous sintered CPP construct may have four effects. Crystal water can diffuse out of the high-water CPP glass, environmental water vapour facilitates the hydrolytic degradation of polyphosphate chains via Reaction 1 in the reverse direction, polyphosphate chains may condense via reaction 1, and/or the amorphous PP glass may begin to crystallize.

Fiber Reinforcement During the Aqueous Sintering Process and Heat Treatment.

Ceramics, such as crystalline, porous CPP samples undergo brittle fracture, rapidly breaking into two pieces after failing under loads such as those imposed by the 4-point bending test. However, CPP samples that were reinforced with acicular crystalline CPP fibers during the novel room-temperature aqueous sintering process demonstrated a higher ultimate tensile stress, and remained intact after initially failing under the same test. Some of the interconnected fibers did not break after the CPP particles in the sample had failed—the fibers served to hold the porous CPP construct together after it was “broken”. The mechanical strength of ceramics can thus be increased by incorporating a second reinforcing phase such as strong fibres into them. The aqueous sintering process provides a simple process for interconnecting multivalent polyphosphate glass with a crystalline CPP fiber and perhaps other reinforcing phases.

The traditional heat treatment process does not offer enough process flexibility to easily provide effective connections between the MVCPP glass particles and stronger crystalline CPP fibers. The aqueous sintering process allows for the effective incorporation of another phase that improves the mechanical properties of the porous CPP construct.

Crystalline CPP fibers, approximately 0.2-1 mm. long were combined with +105-150 μm CPP glass particles to form mixes of 1% and 10% fibers (by weight). These mixes were sintered repeatedly with the aqueous sintering process, which monitored the weight gain with each batch addition of water within the crucible followed by a drying step in ambient conditions.

Water vapour affects the furnace CPP sintering process (Filiaggi, M. et al., supra). To avoid this effect, aqueous sintered CPP solids were heat-treated in a tube furnace in a nitrogen environment. The heating cycle was a 10° C./min ramp rate to 600° C., which was held for one hour. The furnace then cooled by natural convection to ambient temperature. Samples were removed when the temperature within the furnace was less than 100° C.

The porous, interconnected polyphosphate gel-glass with an optional reinforcing phase can be dried in ambient conditions to form a coherent solid. Depending on the temperature, environment (gas type, presence of water vapour), ramp rate, cooling rate, and heating time, the application of heat to this interconnected solid can dry the solid. The gel can dry, transforming the gel into a solid phosphate glass that contains water. Brow et al. (Brow, R. K., Kirkpatrick, R. J., Turner, G. L. “The Short Range Structure of Sodium Phosphate Glasses I. MAS NMR studies”, Journal of Non-Crystalline Solids, 1990, Volume 116, pages 39-45) measured the water content in sodium phosphate glasses. Abe, Y. (Abe, Y., in Topics in Phosphorus Chemistry, ed. M. Grayson, E. J. Griffith, John Wiley and Sons, Toronto, 1983, Volume 11, pages 19-76) reported that calcium phosphate glass also contains water. Depending on the heating conditions, the application of heat can cause one or more of the following phenomena to occur: reduction of the water content in the solid, condensation of the polyphosphate chains, reaction of the particle surface with water vapour and/or oxygen in the environment and partial or total crystallization of the phosphate glass.

Ultimate Tensile Stress—Four Point Bending (Preliminary Results).

The average ultimate tensile stress, failure strain and energy to failure of sintered CPP bars that were heat treated for different lengths of time in a nitrogen environment or reinforced with 1% CPP crystalline fibers are presented in Table 2.

Sintered CPP bars were cut into bars with a diamond wafering blade on a rotating saw (Isomet). The size of the bars was fine-tuned by eroding the surfaces by hand with sandpaper to approximate dimensions 2.5-4.5 mm (height and width)×20-23 mm (length). The guide for fixture spans and specimen aspect ratio and size was ASTM C 1161-94 (ASTM International, Standard Test Method for Flexural Strength of Advance Ceramics at Ambient Temperature, C 1161-94, 221-226, 1996, Annual Book of ASTM Standards).

The geometry of the fixtures used in the 4-point bending test is shown in FIG. 11. The cylindrical bearing edges of the support span were fixed, while the bearing cylinders of the loading span were free to rotate in order to relieve frictional constraints.

Failure properties of CPP sintered with the room-temperature aqueous process, followed by different heat treatments and/or reinforcement with crystalline CPP fibres.

TABLE 2

| CPP heat-treatment, | | | 60 minutes |
|---|---|---|---|
| processed after | | | 600° C., N₂ |
| novel sintering | 1 minute | 60 minutes | 1% fibres |
| process ( | 600° C., N₂ | 600° C., N₂ | (n = 2) |
| UTS (MPa) | 3 | 7 | 17.1 |
| failure strain | 0.05 | 0.02 | 0.06 |
| energy to failure | 0.01 | 0.002 | 0.09 |
| (mJ/mm³) | | | |

The results suggest that the ultimate tensile stress of the aqueous sintered CPP that was heat-treated for 1 hour at 600° C. in nitrogen is within the same order of magnitude of the characteristic stress of 585° C.-sintered CPP (11 MPa). The higher ultimate tensile stress and energy to failure for the fiber-reinforced specimens indicate that aqueous sintering of fiber-reinforcement adds strength and toughness to the heat-treated porous CPP sample. In addition, both fiber-reinforced samples did not break into two separate pieces after they failed under four-point bending. This result suggests that fiber-reinforcement through this aqueous sintering process could be pursued as a method of strengthening porous, brittle sintered CPP ceramic constructs.

X-Ray Diffraction.

CPP specimens were ball-milled for 5 minutes to pulverize the interconnected CPP structure and the component particles for powder X-ray diffraction (Multiflex, Rigaku). Ethanol was used to distribute a thin layer of CPP evenly on a quartz specimen holder. X-ray diffraction patterns were generated from 10 to 50 °2θ at 40 kV and 20 mA. The scan rate was 1 °2θ0 per minute. Using Jades (Materials Data Inc.), X-ray diffraction patterns were overlaid with powder diffraction file data.

XRD—Evidence of β-Ca(PO₃)₂ Formation.

X-ray diffraction is helpful for identifying the components of a crystalline solid. Exposure of CPP to water causes polyphosphate chain hydrolytic degradation. The (in vitro) hydrolytic degradation rate is primarily a function of solvent temperature and pH. At the slightly acidic pH of deionized water (pH 5.5-6.5), it is assumed that the rate of polyphosphate hydrolytic degradation is very slow. This is supported by the total phosphate concentrations being higher than the ortho-phosphate concentrations measured in the solvent solution.

Should a significant fraction of ortho- or pyrophosphates be formed by the aqueous sintering process, they could crystallize as a different phase when the aqueous sintering product is fired at a higher temperature. Different crystalline phases can be identified by powder-X-ray diffraction (PXRD).

Amorphous samples can not be identified by PXRD; their analysis produces one wide peak. A glass does not generate discrete peaks by PXRD because there are not enough atoms positioned at regular distances to diffract the X-rays at a particular °2θ. FIG. 18(a) is the X-ray diffraction pattern of CPP glass that was aqueous sintered in deionized water for 24 hours. This pattern verifies that the aqueous sintering process results in an amorphous product.

Powder-XRD of CPP glass that was heated to 590° C. for 1 hour in nitrogen transforms into a crystalline CPP phase (PDF #11-0039 (CaP₂O₆)—FIG. 18(b)). Powder-XRD of CPP glass that was sintered in 30-40% humid ambient air for 1 hour at 585° C. for 1 hour closer matches PDF #17-0500 (β-CPP (Ca(PO₃)₂)—FIG. 18(c)). One obvious difference between FIGS. 18(b) and (c) is the peak at 20 °2θ. This represents one of a various number of CPP crystal structure that the polyphosphate of the present invention will form. Although crystalline calcium phosphate formed by crystallizing from the melt is identified by PDF #17-0500, it has been determined that heat-treated calcium polyphosphate glass first crystallizes into a phase similar to PDF #11-0039. Further heat treatment results in a phase transformation to the phase identified with PDF #17-0500.

CPP processed by the aqueous sintering method (24 hours in deionized water, dried at a temperature <100° C., then fired for 30 minutes at 600° C. in nitrogen) results in a crystalline product identified by PDF #11-0039 as CaP₂O₆ (FIG. 18(d)). This is evidence that the primary crystalline product of heat treating the product of 24 hours of aqueous sintering in deionized water is calcium polyphosphate, and not calcium polyphosphate or another calcium ortho-phosphate phase.

PAGE: Separation and Detection of Dissolved Phosphate Species.

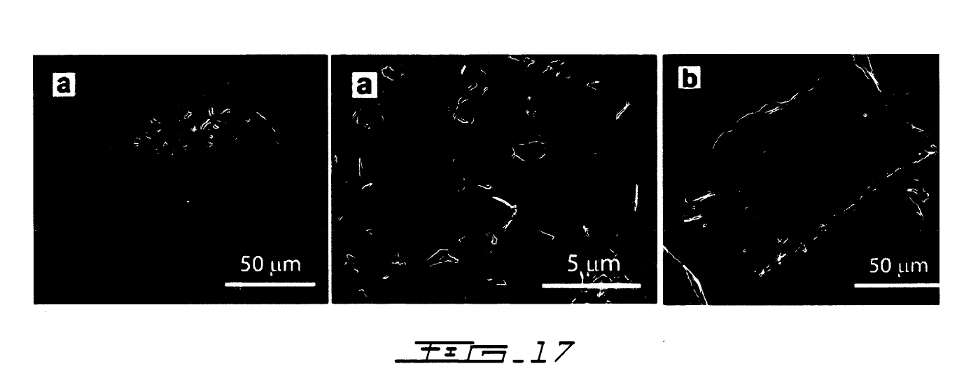

The generation of ortho-phosphate (PO₄³⁻) or pyrophosphate (P₂O₇⁴⁻) species by polyphosphate hydrolytic degradation is possible. The separation and detection of polyphosphate chains of different lengths can be measured by the PAGE method. FIG. 16 shows a PAGE separation of the dissolution products of <75 μm pure CPP glass that was dissolved in 5 mM EDTA (pH 9) for 1 hour in lane 4. Compared with: Lane 1 containing pyrophosphate (P₂O₇⁴⁻) and a trimetaphosphate ring (PO₃)₃⁻; Lane 2 containing pyrophosphate and a small amount of (PO₃⁻)ₙ where n˜41; and Lane 3 containing (PO₃⁻)ₙ where n˜28 and orthophosphate (PO₄³⁻).

Linear, long-chain polyphosphate standards were obtained by dissolving sodium phosphate glasses (poly(P) glass types 25 and 45, with an average number of 28 and 41 phosphate units, respectively) and trisodium trimetaphosphate (three-phosphate ring) that were all procured from Sigma-Aldrich. Sodium pyrophosphate (phosphate chain length: 2) and sodium phosphate dibasic, anhydrous (sodium phosphate), (phosphate standard) were both purchased from Fisher Scientific. Polyacryamide gels and the running buffer were composed of Sigma-Aldrich products: acrylamide/bis-acrylamide 40\% stock solution mixture (19:1 ratio), urea, and TBE (Trizma® base), boric acid and disodium EDTA, except for boric acid, which was purchased from BDH Chemicals. PA Polymerization was initiated with ammonium persulphate and accelerated with TEMED; both were procured from Sigma-Aldrich. The sample loading buffer contained bromphenol blue as the dye of choice, and sucrose to increase its density; both were purchased from Sigma-Aldrich. Hydrochloric acid and sodium chloride from Fisher Scientific was used to hydrolytically degrade the polyphosphate chains in the gel. Ammonium molybdate and sulphuric acid from Fisher Scientific and ascorbic acid procured from Gibco Chemical Co. were used to detect orthophosphate species in the gel produced after hydrolytic degradation.

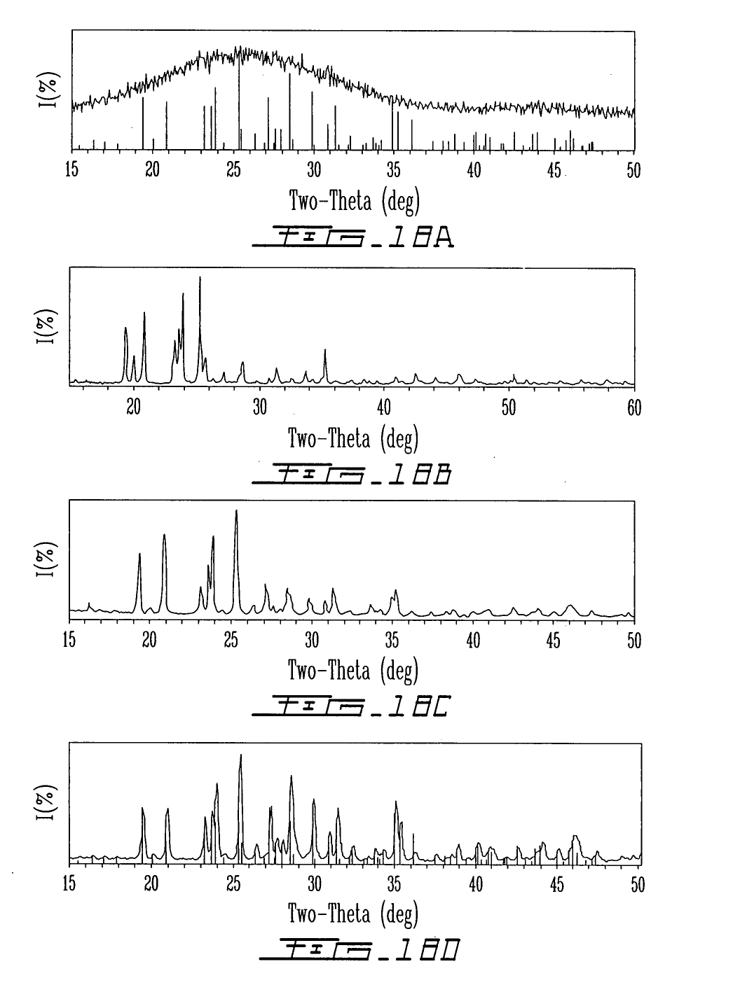

The identification of polyphosphate species of length >2 phosphate units in the CPP glass dissolution products allows for the preliminary conclusion that polyphosphate chains of length ˜10-20 phosphate units are one of the dissolution products of CPP glass in deionized water. While it is clear that ortho- and pyrophosphate species are also dissolution products, this result must also be qualified by the fact that the CPP glass was not stored in a dessicator. FIG. 17(a,b) shows a difference between CPP glass that was stored in air for 1 year (a) and the same glass after it was washed in a rapid deionized water rinse (b). The crystallites that have formed on the surface of the CPP glass are assumed to be crystallites of smaller phosphate chains, likely pyrophosphates, formed by polyphosphate chain hydrolytic degradation caused by ambient water vapour.

It is clear that small, rapidly-dissolving crystals have formed on the surface of the glass while it was stored. It is assumed that water vapour reacted with the surface of the CPP glass, hydrolytically degrading polyphosphate chains into smaller species (possibly pyrophosphates and/or orthophosphates). These rapidly-dissolving crystallites are proposed to be the source of the ortho- and pyrophosphates detected in the PAGE gel, especially with the high surface area to volume ratio of <75 μm particles.

The embodiments of the invention described above are intended to be exemplary. Those skilled in the art will therefore appreciate that the forgoing description is illustrative only, and that various alternatives and modifications can be devised without departing from the spirit of the present invention. Accordingly, the present is intended to embrace all such alternatives, modifications and variances which fall within the scope of the appended claims.

1. A porous polyphosphate ceramic comprising:
a network of interconnected polyphosphate particles,
each interconnected polyphosphate particle comprising
a polyphosphate core having an outer layer of a dried polyphosphate gel, the gel forming an outer surface of each particle,
the dried polyphosphate gel comprising
an amorphous polyphosphate,
a multivalent cation, and
a solvent,
wherein adjacent interconnected polyphosphate particles integrate in a region of their respective outer layers to form the network.

2. The polyphosphate ceramic of claim 1, wherein a reinforcing phase is integrated within the outer region.

3. The polyphosphate ceramic of claim 1, wherein the solvent is water.

4. The polyphosphate ceramic of any one of claims 1 to 3, wherein the polyphosphate core is primarily an amorphous multivalent cation polyphosphate.

5. The polyphosphate ceramic of any one of claims 1 to 4, wherein the interconnected polyphosphate particles comprise a crystalline or partially crystalline multivalent cation polyphosphate.

6. The polyphosphate ceramic of any one of claims 1 to 5, wherein the multivalent cation is a divalent cation.

7. The polyphosphate of any one of claims 1 to 5, wherein the amorphous polyphosphate initially comprises a monovalent cation mixed with the multivalent cation.

8. The polyphosphate ceramic of any one of claims 1 to 7, wherein the multivalent cation is a calcium cation.

9. The polyphosphate ceramic of any one of claims 1 to 7, wherein the multivalent cation is a magnesium cation.

10. The polyphosphate ceramic of any one of claims 1 to 7, wherein the multivalent cation is a ferric Fe³⁺ cation.

11. The polyphosphate ceramic of claim 7, wherein the divalent cation is a calcium cation and the monovalent cation is at least one of sodium and potassium.

12. The polyphosphate ceramic of claim 6, wherein the divalent cation is calcium.

13. A method of producing a porous polyphosphate ceramic comprising:
a)providing a plurality of particles of a polyphosphate, of a multivalent cation;
b)adding solvent to the plurality of particles to partially dissolve the plurality of particles and to produce a hydrogel on outer surfaces of the particles;
c)allowing the hydrogel on the outer surfaces between adjacent particles to integrate; and
d)drying the thus integrated particles to produce the porous polyphosphate ceramic.

14. The method of claim 13, wherein the plurality of particles is of an amorphous polyphosphate.

15. The method of claim 13, wherein the plurality of particles is a mixture of amorphous and crystalline polyphosphates.

16. The method of claim 13, comprising heating the plurality of polyphosphate particles to partially convert the plurality of polyphosphate particles to a crystalline polyphosphate ceramic after drying the integrated particles.

17. The method of claim 13, comprising providing at least one monovalent polyphosphate to the plurality of polyphosphate particles in step a).

18. The method of claim 13, comprising providing a reinforcing phase to the plurality of polyphosphate particles in step a).

19. The method of claim 13, wherein the solvent is water.
